(19) United States
(12) Patent Application Publication
(10) Pub. No.: US 2001/0026604 A1
(43) Pub. Date: Oct. 4, 2001

(54) Method for controlling zinc addition to power reactor

(75) Inventor: William J. Marble, Santa Clara, CA (US)

Correspondence Address: Nixon & Vanderhye P.C., 8th Floor, 1100 N. Glebe Rd., Arlington, VA, 22201, US

(73) Assignee: General Electric Company

(21) Appl. No.: 09/818,777

(22) Filed: Mar. 28, 2001

Related U.S. Application Data
(63) Continuation of application No. 09/198,569, filed on Nov. 23, 1998, now abandoned.
(60) Provisional application No. 60/103,152, filed on Oct. 5, 1998.

(51) Int. Cl. G21C 9/00

(52) U.S. Cl. 376/306

(57) ABSTRACT

Method for controlling the introduction of zinc to a nuclear power reactor to control radiation build-up wherein zinc ions are introduced into the reactor water to counteract loss of zinc within the reactor system. In the process, the rate of introduction of zinc ions into the reactor water is balanced with the rate at which zinc ions are lost from the reactor.

The present application relates generally to reducing radiation build-up in nuclear power reactors. More particularly, the invention provides a method of controlling the concentration of zinc in the reactor water in order to counteract loss of zinc from the water to the reactor system.

### BACKGROUND OF THE INVENTION

A major problem in water-cooled nuclear reactors is the accumulation of radioactive substances in the structural portions of the reactor system. For example, during reactor shut-down, workers are exposed to radiation emanating from internal walls and tubing surfaces, and radioactive materials retained in oxide films which have accumulated on these surfaces are a major source of radiation exposure.

The build-up of radioactive cobalt (⁶⁰Co) in recirculation piping of nuclear power reactors, including boiling water reactors, is a major source of radiation exposure, especially during reactor shutdown. Efforts have been made during recent years to identify parameters which affect the rate and magnitude of ⁶⁰Co buildup, with a view to developing methods for limiting the buildup. It has been shown in prior work that the majority of ⁶⁰Co buildup in recirculation piping occurs by incorporation of ⁶⁰Co into the oxide film during formation of the oxide film on stainless steel surfaces.

U.S. Pat. No. 4,950,449 describes the use of zinc ions to remove or lessen deposition of radioactive substances and reduce intergranular stress corrosion cracking in water-cooled nuclear reactors. The zinc may be added in the form of zinc oxide paste, slurry or aqueous solution.

U.S. Pat. No. 4,756,874 describes the use of zinc having a lower content of the ⁶⁴Zn isotope in order to reduce accumulation of radioactive cobalt without increasing the presence of the ⁶⁵Zn activation product of ⁶⁴Zn. The zinc in this form may be added to the reactor water in the form of a zinc salt or zinc oxide.

U.S. Pat. No. 4,759,900 relates to the inhibition of deposition of radioactive cobalt by continuous injection of zinc oxide into the reactor water. The zinc oxide may be prepared in the form of a paste, slurry or aqueous solution.

A need exists for improvement in the control and monitoring of zinc addition to power reactors to better control the build-up of radioactive materials therein. The present invention seeks to satisfy that need.

### SUMMARY OF THE INVENTION

It has been discovered, according to the present invention, that radiation build-up in a nuclear power reactor can be controlled by establishing in the water of the reactor a stable concentration of ionic zinc. This permits beneficial mechanisms to reach and maintain a stable equilibrium.

According to one aspect, the present invention provides a method of controlling zinc addition to a nuclear power reactor to control radiation build-up wherein zinc ions are introduced into the reactor water, which comprises balancing the rate of introduction of zinc ions into the reactor water with the rate at which zinc ions are lost to the reactor system.

### BRIEF DESCRIPTION OF THE DRAWINGS

The invention will now be described with reference to the accompanying drawings, in which:

FIG. 1 is a simplified boiling water reactor flowchart for zinc mass balance; and

FIG. 2 is a plot showing a comparison of the empirical equation for zinc concentration factor (CF) and actual plant data.

### DETAILED DESCRIPTION OF THE INVENTION

The basis of the zinc addition process of the present invention is that a stable concentration of ionic zinc is established and maintained in the reactor water to permit the beneficial mechanisms pertaining to the control of radiation build-up to reach and maintain an equilibrium. It has been determined according to the present invention that the higher the concentration of ionic zinc, the better are the results in terms of reduction of ⁶⁰Co build-up. To achieve this equilibrium, it is necessary to approximate the zinc loss mechanisms which must be balanced against the zinc input so that the radiation build-up prevention process remains stable. This zinc material balance has been developed and subsequently improved by using plant operating data to determine empirical coefficients.

The fundamental mass balance equation is

Zinc In=Zinc Out+Zinc Accumulation (1)

(a) Zinc In

The amount of zinc entering the reactor is the sum total of the soluble and insoluble zinc concentration in the final feedwater multiplied by the final feedwater flow rate:

Zinc In=F×(Zn_{Fs}+Zn_{F1})

where:

F=Feedwater flow rate (M#/hr)

Zn_{Fs}=Soluble zinc concentration in the feedwater (ppb)

Zn_{F1}=Insoluble zinc concentration in the feedwater (ppb)

(b) Zinc Out

The amount of zinc leaving the reactor consists of the zinc removed by the reactor water cleanup (RWCU) system and the zinc carried over in the stream.

Zinc Out=R×{((Zn_{Rs}+Zn_{R1})−(Zn_{RE1})}+(S×Zn_{S}) (3)

where:

R=Reactor water clean up flow rate (M#/hr)

Zn_{Rs}=Soluble zinc concentration in the reactor water (ppb)

Zn_{R1}=Insoluble zinc concentration in the reactor water (ppb)

Zn_{REs}=Soluble zinc concentration in the RWCU effluent (ppb)

Zn_{RE1}=Insoluble zinc concentration in the RWCU effluent (ppb)

S=Steam flow rate (M#/hr)

Zn_{S}=Total zinc concentration in the steam (ppb)

The carryover of soluble species to the steam is generally accepted to be a factor of 10⁻³ or less. As such, the amount of zinc lost to the steam is assumed to be trivial for the purposes of a mass balance.

(c) Zinc Accumulation

The accumulation is defined as being a combination of the zinc which is incorporated with the particulate iron entering with the feedwater (most of which is deposited on the fuel cladding), the zinc which is deposited on the fuel cladding surface as a result of the boiling process, and the zinc which is incorporated into the oxide film forming on the primary system surfaces. The equations follow:

Zinc Accumulation=(Zinc to Particulate)+(Zinc To Boiling Deposition)+(Zinc To Corrosion Film Incorporation) (4)

It is necessary to break the above equation into its component parts to assess the key factors for each. First, evaluating the particulate incorporation:

Zinc To Particulate=F×(Fe_{Fs}+Fe_{F1})×(a×Zn_{Rs}) (5)

where:

Fe_{Fs}=Soluble iron concentration in the feed water (ppb)

Fe_{F1}=Insoluble iron concentration in the feedwater (ppb)

a=Incorporation fraction for zinc (#Zn/#Fe/ppb of zinc)

Zn_{Rs}=Soluble zinc concentration in the reactor water (ppb)

S=Steam flow rate (M#/hr)

Zn_{S}=Total zinc concentration in the steam (ppb)

Second, is an evaluation of the boiling deposition:

Zinc to Boiling Deposition=F×(b×Zn_{Rs}) (6)

where:

b=Boiling deposition fraction for zinc (#Zn/#H₂O/ppb of zinc)

Third, the incorporation of zinc into the corrosion films on system surfaces is extremely complex and is formulated as follows:

Zinc to Corrosion Film Incorporation=(c×Zn_{Rs})×ƒC₍ₜ₎dt (7)

where:

c=corrosion fraction for zinc (#Sn/# Oxide/ppb of Zn)

C₍ₜ₎=Oxide formation rate as function of time (# Oxide/hr)

t=time (hr)

The value of “c” is almost certain to be different for each material which incorporates zinc (i.e., stainless steel, Inconel, Stellite, etc.). The corrosion for each material is logarithmic in nature but will have different magnitudes, and will vary as a function of environment (e.g. NWC vs. HWC). Consequently this part of the zinc consumption is extremely difficult, if not impossible, to determine when the surfaces are fresh. However, after the first several months of zinc addition, this consumption effect becomes negligible compared to the others and can be ignored.

Zinc ions are typically introduced at a rate to produce a zinc ion concentration of about 1 parts per billion (ppb) to 100 ppb. More typically, the zinc ion concentration is about 1 ppb to about 50 ppb.

The zinc is usually introduced by using a source of zinc oxide. For example, it is possible to add a zinc oxide aqueous suspension into the reactor feed water. Alternatively, it is possible to use a side-stream to dissolve zinc ions from a bed of sintered oxide pellets. During stable operation, zinc is removed from the reactor water by RWCU and by adsorption into the particulate iron that enters the reactor water with the feed water.

The temperature of the reactor water is typically in the range of 120-550° F. (BWR), 120-650° F. (PWR). The temperature is generally in the range of 212-350° F., more usually about 340°-360° F.

The next step is to determine how much zinc will be required to maintain any given concentration in the reactor water. From the zinc balance approach developed above, an empirical equation has been developed which estimates the concentration factor for zinc between the reactor water and the feed water. This equation is as follows:

CF=1/{(0.9*RWCU)+(0.02*Fe_{FW})+(0.008)} (8)

where:

CF=Concentration Factor (R×W Zn/FW Zn)

RWCU=Size of the reactor water cleanup system (% of FW flow)

Fe_{FW}=Total iron concentration in the feedwater (ppb)

In the above equation (8), 0.9 represents the efficiency of removal by the reactor water cleanup system, 0.02 represents the amount of zinc absorbed by the feedwater iron per ppb of zinc in the reactor water (“a” in Equation 5), and 0.008 represents the boiling deposition factor for zinc (“b” in Equation 6).

This leads to a zinc consumption rate equation of

Zn#/yr={(Zn_{R}*0.9*RWCU)+Zn_{R}*0.02(*Fe_{FW})+(Zn_{R}*0.008)}*FW*(1E−9)*24*365

where:

Zn_{R}=Target reactor water zinc concentration (ppb)

FW=Feedwater flow rate (lbs/hr)

The above equation yields the pounds of zinc required per year. In order to get the total pounds of ZnO required, the answer must be divided by 0.8.

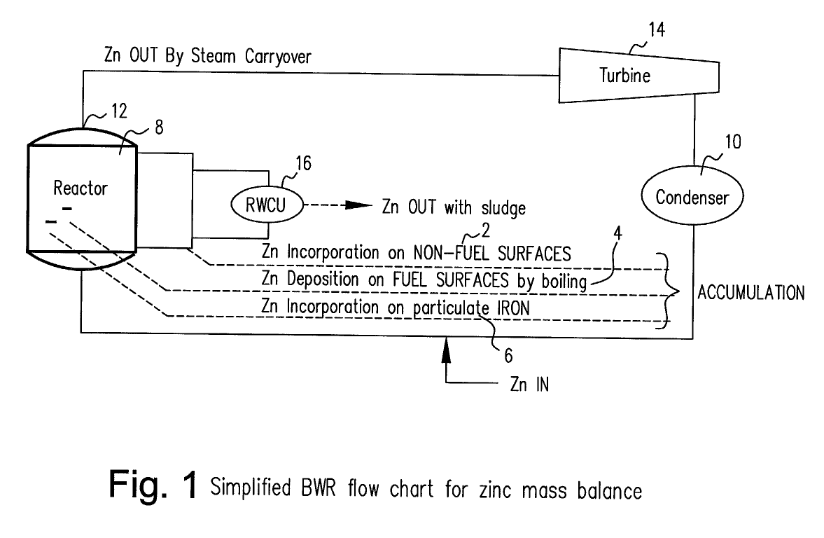

FIG. 1 is a simplified boiling water reactor flow chart for the zinc mass balance developed according to the present invention. The zinc accumulation is shown as comprising zinc incorporation on non-fuel surfaces (2), zinc deposition on fuel surfaces by boiling (4) and zinc incorporation on particulate iron (6). Zinc is shown as entering the reactor (8) in the feed water stream to the reactor. The zinc leaves by way of the top (12) of the reactor by steam carryover to the turbine (14) and by way of the reactor water cleanup (RWCU) system (16).

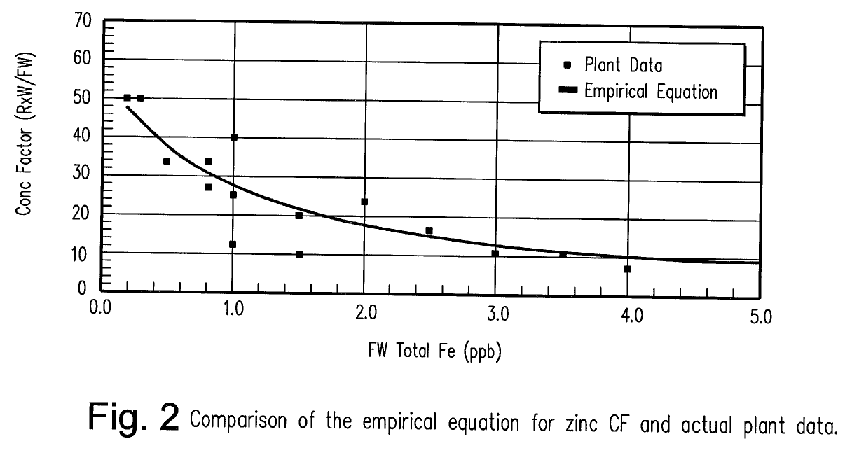

FIG. 2 shows a plot of the empirical concentration factor (CF) equation. The blackened squares are actual plant data and the blackened rectangles are obtained from the equations. It can be seen from FIG. 2 that a reasonably good fit exists as between the two sets of data.

### EXAMPLE

The following example illustrates the present invention.

Assuming a specific plant averaged 1.5 ppb total iron in the feedwater, a zinc concentration factor approximately 20 would be expected. At a target reactor water zinc concentration of 10 ppb, the feedwater zinc concentration would need to be 0.5 ppb. For a feedwater flow of 10 million lbs/hr with a 1% cleanup system, the equation calculates that 41.2 lbs/yr of zinc (assuming full power operation all year) would be required, or 51.5 lbs/yr (23.4 kg/yr) of zinc oxide.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim:

1. A method of controlling zinc addition to a nuclear power reactor to control radiation build-up wherein zinc ions are introduced into the reactor water, which comprises balancing the rate of introduction of zinc ions into the reactor water with the rate at which zinc ions are lost to the reactor system.

2. A method according to claim 1, wherein the zinc ions are introduced to produce a zinc ion concentration of about 1 ppb to 100 ppb.

3. A method according to claim 2, wherein the zinc ion concentration is about 1 ppb to 50 ppb.

4. A method according to claim 1, wherein the zinc ions are introduced according to the equation:
Zinc In=Zinc Out+Zinc Accumulation
wherein zinc in is the amount of zinc entering the reactor water, zinc out is the amount of zinc lost to system processes, and zinc accumulation is combination of the zinc which is incorporated with particulate iron entering with feedwater, zinc which is deposited on the fuel cladding surface as a result of boiling, and zinc which is incorporated into oxide film which forms on surfaces of the reactor and components thereof.

5. A method according to claim 4, wherein zinc in is defined by the equation:
Zinc In=F×(Zn_{FS}+Zn_{F1})
where:
F=Feedwater flow rate (M#/hr)
Zn_{FS}=Soluble zinc concentration in the feedwater (ppb)
Zn_{F1}=Insoluble zinc concentration in the feedwater (ppb).

6. A method according to claim 5, wherein zinc out is defined by the equation:
Zinc Out=R×{((Zn_{Rs}+Zn_{R1})−(Zn_{REs}+Zn_{RE1})}+(S×Zn_{S}) (3)
where:
R=Reactor water clean up flow rate (M#/hr)
Zn_{Rs}=Soluble zinc concentration in the reactor water (ppb)
Zn_{R1}=Insoluble zinc concentration in the reactor water (ppb)
Zn_{REs}=Soluble zinc concentration in the RWCU effluent (ppb)
Zn_{RE1}=Insoluble zinc concentration in the RWCU effluent (ppb)
S=Steam flow rate (M#/hr)
Zn_{S}=Total zinc concentration in the steam (ppb)

7. A method according to claim 6, wherein zinc accumulation is defined by the equation:
Zinc Accumulation=(Zinc to Particulate)+(Zinc To Boiling Deposition)+(Zinc To Corrosion Film Incorporation) (4)

8. A method according to claim 7, wherein zinc to particulate incorporation is defined by the equation:
Zinc To Particulate=F×(Fe_{Fs}+Fe_{F1})×(a×Zn_{Rs}) (5)
where:
Fe_{Fs}=Soluble iron concentration in the feed water (ppb)
Fe_{F1}=Insoluble iron concentration in the feedwater (ppb)
a=Incorporation fraction for zinc (# Zn/# Fe/ppb of zinc)
Zn_{Rs}=Soluble zinc concentration in the reactor water (ppb)
S=Steam flow rate (M#/hr)
Zn_{S}=Total zinc concentration in the steam (ppb).

9. A method according to claim 8, wherein zinc to boiling deposition is defined by the equation:
Zinc to Boiling Deposition=F×(b×Zn_{Rs}) (6)
where:
b=Boiling deposition fraction for zinc (# Zn/# H₂O/ppb of zinc).

10. A method according to claim 9, wherein zinc to corrosion film incorporation is defined by the equation:
Zinc to Corrosion Film Incorporation=(c×Zn_{Rs})×ƒC₍ₜ₎dt (7)
where:
c=corrosion incorporation fraction for zinc (# Zn/# Oxide/ppb of Zn)
C₍ₜ₎=Oxide formation rate as function of time (# Oxide/hr)
t=time (hr)

11. A method for estimating the concentration factor for zinc between the reactor water and the feed water of a nuclear reactor comprising using the equation:
CF=1/{(0.9*RWCU)+(0.02*Fe_{FW})+(0.008)} (8)
where:
CF=Concentration Factor (R×W Zn/FW Zn)
RWCU=Size of the reactor water cleanup system (% of FW flow)
Fe_{FW}=Total iron concentration in the feedwater ppb)
wherein 0.9 represents the efficiency of removal by the reactor water cleanup system, 0.02 represents the amount of zinc absorbed by the feedwater iron per ppb of zinc in the reactor water, and 0.008 represents the boiling deposition factor for zinc.

12. A method according to claim 11, wherein the consumption rate of zinc is defined by the equation:
Zn#/yr={(Zn_{R}*0.9*RWCU)+Zn_{R}*0.02(*Fe_{Fw})+(Zn_{R}*0.008)}*FW*(1E−9)*24*365
where:
Zn_{R}=Target reactor water zinc concentration (ppb)
FW=Feedwater flow rate (lbs/hr)

13. A method according to claim 12, wherein the total pounds of ZnO required is obtained by dividing the answer obtained according to the equation as defined in claim 14 by 0.8.
